(19) United States
(12) Patent Application Publication
(10) Pub. No.: US 2025/0385059 A1
(43) Pub. Date: Dec. 18, 2025

(54) HIGH VOLTAGE CIRCUIT-BREAKER HAVING AN OPTIMIZED CONTACTS DESIGN

(71) Applicant: GE Vernova Infrastructure Technology LLC, Greenville, SC (US)

(72) Inventors: Cyril GRÉGOIRE, Villeurbanne (FR); Elisa PERRET, Villeurbanne (FR)

(73) Assignee: GE Vernova Infrastructure Technology LLC, Greenville, SC (US)

(21) Appl. No.: 19/230,720

(22) Filed: Jun. 6, 2025

(30) Foreign Application Priority Data
Jun. 12, 2024 (EP) 24181785.7

(51) Int. Cl. H01H 33/74; H01H 33/56; H01H 33/70

(52) U.S. Cl. CPC H01H 33/74; H01H 33/56; H01H 33/703; H01H 2033/566

(57) ABSTRACT

A circuit breaker for a HV Circuit-breaker includes a pair of permanent contacts, at least one of them being movable along an axis; an insulating nozzle having a central cylindrical wall defining a longitudinal cylindrical hole, along the axis; a pair of arcing contacts, at least one of them being movable along the axis, a lateral wall of one of the arcing contacts being at a distance from the central cylindrical wall thereby defining a cylindrical volume between the arcing contact and the central cylindrical wall, the arcing contact further comprising at least one inner central channel extending along the axis and along part of the arcing contact, and at least one lateral conduit between the at least one inner channel and at least one lateral hole.

### TECHNICAL FIELD

The invention concerns circuit breakers for high voltage applications. It is dedicated to all ranges of High Voltage circuit breaker filled with SF₆ or any other alternative gas to SF₆, for example a mixture of CO₂, O₂ and fluoronitrile, or a mixture of CO₂ and Fluoronitrile, or a mixture of CO₂ and O₂, or a mixture of CO₂, O₂ and Fluoroketone, or a mixture of CO₂ and Fluoroketone, or a mixture of N₂ and fluoronitrile.

### BACKGROUND

Sulfur hexafluoride (SF₆) being estimated to contribute to the greenhouse effect, it is being replaced by another gas, for example so-called “g3” gas, comprising heptafluoroisobutyronitrile mixed with a dilution gas comprising carbon dioxide and oxygen is used in replacement of SF₆, opening the path to a new generation of high voltage (HV) electrical transmission equipment. This g3 gas has a drastically reduced environmental impact (more than 99% less gas global warming potential (GWP)).

In the past, when designing old generation of SF₆ circuit breakers, it was common to use a hollow pin with a through hole on the whole length of the pin contact. An example of this technology is described in FR 2980033. These old puffer-type circuit breakers were then replaced by modern self-blast type technology, in which a hollow pin was not used anymore.

Now, a new generation of HV Circuit breaker is being developed relying on SF₆-free gas mixtures examples of which have been given above. These SF₆-free gas mixtures have reduced breaking performances, which induces the need for design improvements for the arc quenching performances.

There is the technical problem of improving the breaking performances of circuit breaker interrupters, in particular of those implementing SF₆-free gas mixtures.

There is thus the problem of finding a new structure of circuit breaker, in particular of the type implementing SF₆-free gas mixtures, for example one of the above-mentioned SF₆-free gas mixtures.

There is also the problem of finding a new process for opening a circuit breaker, in particular of the type implementing SF₆ free gas mixtures, for example one of the above-mentioned SF₆-free gas mixtures.

### SUMMARY OF THE INVENTION

In order to solve one or more of the above problems, the inventors have found a new structure of circuit breaker and a new process for opening a circuit-breaker.

The invention first concerns a HV circuit-breaker comprising:
a pair of permanent or main contacts, at least one of them being movable along an axis (AA′), called the axis of the circuit-breaker;
an insulating nozzle comprising a central cylindrical wall defining a longitudinal cylindrical hole or ring, along said axis (AA′);
a pair of arcing contacts, at least one of them being movable along said axis (AA′), a lateral wall of one of said arcing contacts being at a distance from said central cylindrical wall thereby defining a volume between said arcing contact and said central wall, said arcing contact further comprising at least one inner channel extending along said (AA′) axis and along part of said arcing contact, and at least one lateral conduit extending from said at least one inner channel to at least one lateral hole or outlet whereby said at least one inner channel of said arcing contact communicates with said cylindrical volume.

The arcing contact comprising at least one inner channel and at least one lateral conduit allows an enhancement of the breaking performance.

When the circuit breaker opens the arcing contacts, an arc is established and hot gas is generated.

This hot gas flows either in the at least one inner channel and/or through the other contact, for example a tulip contact, and/or in the volume between the arcing contact and the cylindrical wall of the insulating nozzle. The at least one inner channel thus allows an additional cross-section to evacuate hot gas.

When the at least one radial outlet of the pin hole is closed by the insulating nozzle, the gas flow is very limited. When the radial or lateral outlet(s) is/are released, the at least one inner channel is opened and gas can be released through it, through the at least one lateral outlet and for example into an exhaust volume.

The at least one inner channel inside the arcing contact allows part of the hot gas generated by the arc to flow into the arcing contact.

The at least one inner channel has a limited length which allows a limited pressure drop inside the channel. This limited channel length will also allow to close or open the at least one radial outlet to trigger the opening of said outlet after a predetermined stroke. This allows releasing the blast at the required position.

The length of the at least one inner channel is selected to release the lateral hole only when needed. If said length is too short, the circuit breaker according to the invention has limited effects. If it is too long, an unnecessary early pressure drop may be created inside said at least one channel. In an embodiment, said at least one inner channel extends along said (AA′) axis over a distance X between 10 mm and 150 mm.

Said at least one lateral conduit can extend:
along an axis perpendicular to said axis (AA′) of the circuit breaker;
or along an axis which forms an angle α<90° with said axis (AA′) of the circuit breaker.
or along an axis which forms an angle α>90° with said axis (AA′) of the circuit breaker.

Said angle is therefore selected to increase the exhaust section and to favour a maximum flow rate when the at least one radial outlet is released

For example, said angle can be comprised between 4° and 60°.

In a circuit breaker according to the invention, said at least one inner channel can have a diameter comprised between 1 and 8 mm; said diameter is preferably selected to avoid large gas flow through the hole which would be problematic for some gases, in particular when CO₂ based gas mixtures—which leak more easily than former SF₆ based gas—are used.

An equivalent overall cross section of the said at least one inner channel can also be realized with a series of 2 or more smaller channels having overall the same cross section as a single channel. The shape of the at least one inner channel is preferentially cylindrical but can also be of oval, rectangular cross section or even helicoidal. Any shape providing a cross section with a single or multiple channel is covered in this application.

A circuit breaker according to the invention can be housed in an enclosure (metallic or insulating) filled with a gas.

The gas can be for example SF₆, but alternatively it can comprise an alternative gas, for example comprising heptafluoro-isobutyronitrile (CAS No. 42532-60-5) and/or heptafluoroisopropyl trifluoromethyl ketone (also named 2-butanone, 1,1,1,3,4,4,4-heptafluoro-3-(trifluoromethyl)-(CAS No 756-12-7)) and/or CO₂ and/or O₂ and/or N₂ and/or an oxygenated compounds; for example it can comprise both CO₂ and a fluorinated compound, for example heptafluoroisobutyronitrile and/or heptafluoroisopropyl trifluoromethyl ketone.

Alternatively, said gas comprises a mixture of CO₂, O₂ and fluoronitrile, or a mixture of CO₂ and Fluoronitrile, or a mixture of CO₂ and O₂, or a mixture of CO₂, O₂ and Fluoroketone, or a mixture of CO₂ and Fluoroketone, or a mixture of N₂ and fluoronitrile.

The invention also concerns a method for opening a circuit breaker according to the invention, as disclosed above or in this application; in an embodiment, it comprises:
opening the main contacts and then the pair of arcing contacts;
then opening or separating said pair of arcing contacts from each other, thereby triggering an arc between them, a gas flowing along said central channel extending along said (AA′) axis, and then along said lateral conduit thereby escaping to said cylindrical volume and the to an exhaust volume.

The invention improves the known devices by:
restricting the hole maximum cross section; this offers the advantage of limiting leaks of gases such as for example CO₂ or any CO₂-based gas mixture;
limiting the length of the channel through the pin;
releasing the pin hole outlet only when needed;
optimizing the hole angle outlet.

### BRIEF DESCRIPTION OF THE DRAWINGS

FIGS. 1A-1C show examples of a circuit-breaker according to the invention;

FIGS. 2-4 show other embodiments of a circuit-breaker according to the invention;

FIGS. 5A-5B other views of embodiments of a circuit-breaker according to the invention, in a closed position (FIG. 5A) and in an open position (FIG. 5B);

FIGS. 6A-6B show variants of a pin of a circuit-breaker according to the invention;

FIGS. 7A-7B show a comparative example of a known circuit-breaker and a circuit-breaker according to the invention.

### DETAILED DESCRIPTION OF SPECIFIC EMBODIMENTS

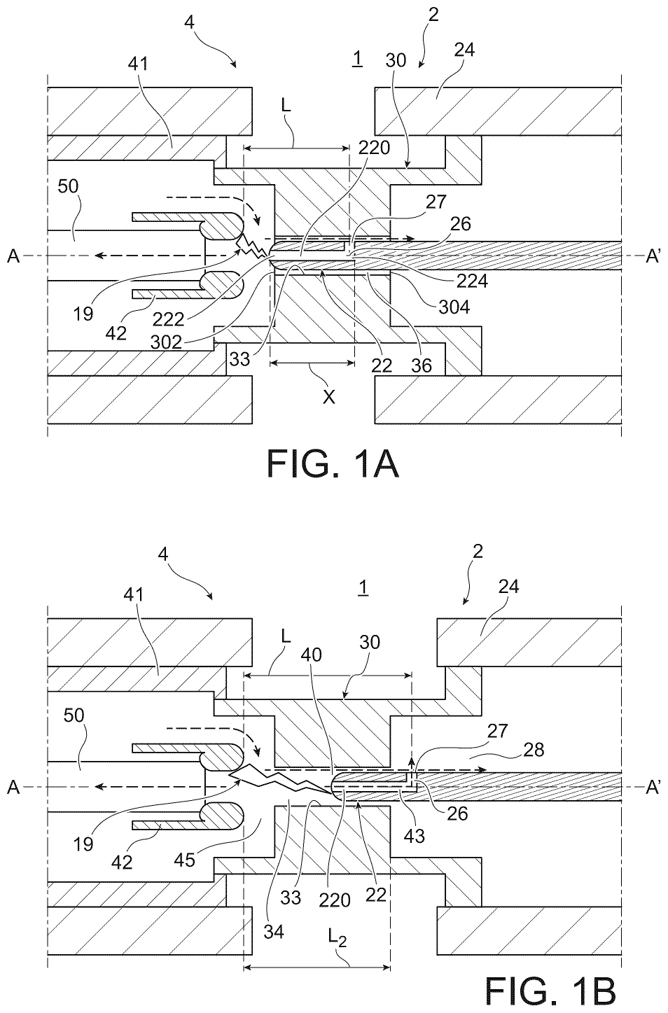

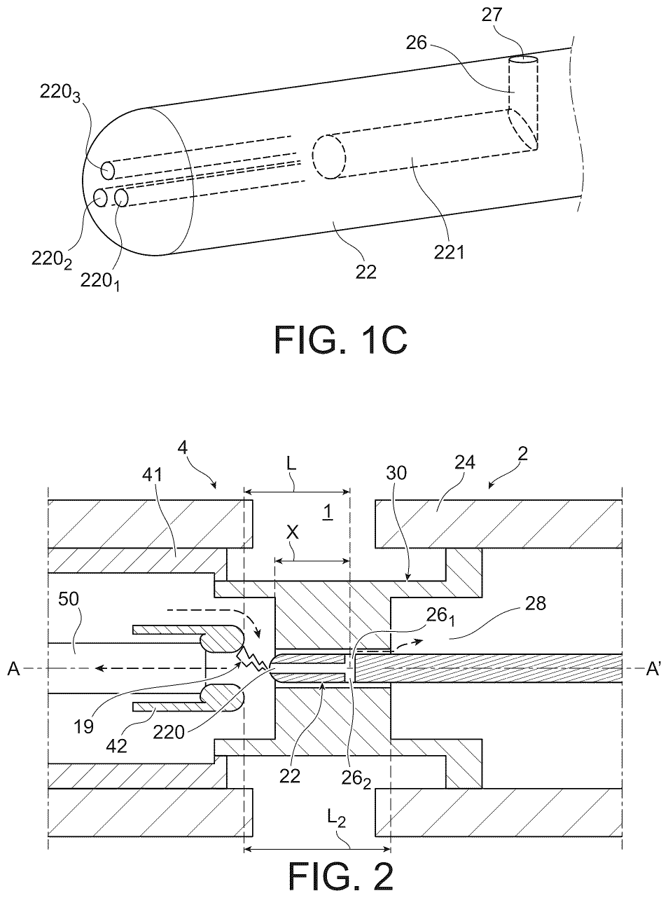

Embodiments of a circuit-breaker 1 according to the invention will be explained in connection with FIGS. 1A-5B.

Each of them forms part of an enclosure or tank (not illustrated), for example metallic or insulating, or of an interrupting chamber. The tank or the interrupting chamber is filled with a gas, for example SF₆ or another gas, for example comprising heptafluoroisobutyronitrile (CAS No. 42532-60-5) and/or heptafluoroisopropyl trifluoromethyl ketone (also named 2-butanone, 1,1,1,3,4,4,4-heptafluoro-3-(trifluoromethyl)-(CAS No 756-12-7)) and/or CO₂ and/or 02 and/or N₂ and/or an oxygenated compounds; for example said other gas can comprise both CO₂ and a fluorinated compound, for example heptafluoroisobutyronitrile and/or heptafluoroisopropyl trifluoromethyl ketone. Another possible gas is a mixture of CO₂, O₂ and fluoronitrile, or a mixture of CO₂ and Fluoronitrile, or a mixture of CO₂ and O₂, or a mixture of CO₂, O₂ and Fluoroketone, or a mixture of CO₂ and Fluoroketone, or a mixture of N₂ and fluoronitrile.

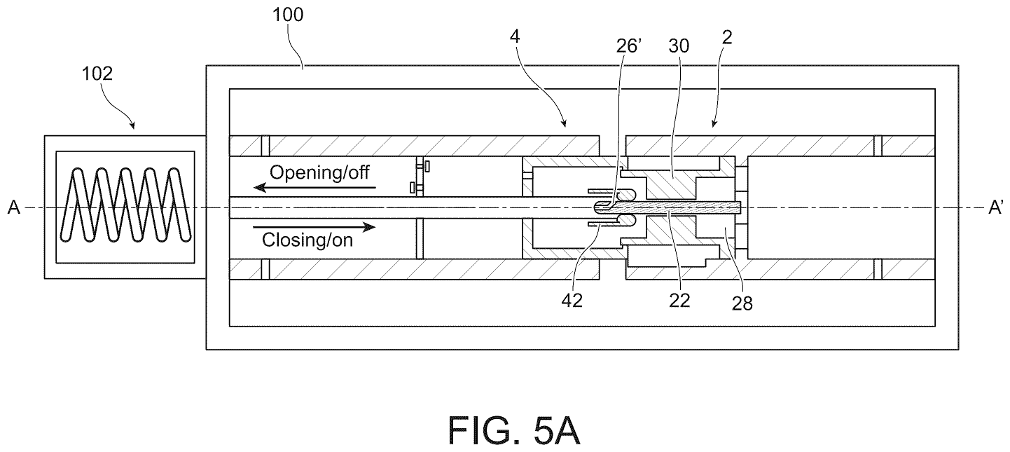

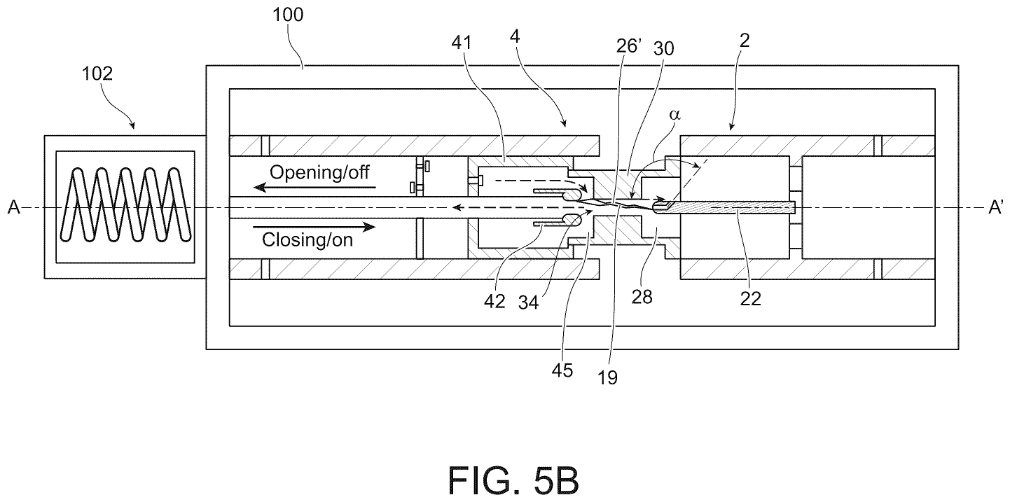

A circuit-breaker 1 according to the invention extends along an axis AA′ and which comprises a pair of contacts 2, 4 mounted to move relative to each other along said axis AA′ with help of an actuation system 102 (see for example FIGS. 5A and 5B). They can move from a closed position in which the electric current can flow to an open position in which the electric current is interrupted and vice-versa. FIGS. 5A and 5B show an embodiment of a circuit-breaker according to the invention implementing a double motion, in a closed position (FIG. 5A) and in an open position (FIG. 5B).

By convention, the term “main contact” is used to designate an electrical contact via which the rated current passes; the main contact is associated with an “arcing contact” which performs the function of breaking the arc. The term “movable contact” is used to designate the main and arcing contact assembly that is connected directly to the actuation system.

The high voltage circuit-breaker comprises:
a first movable contact 4 comprising an arcing contact 42, for example in the form of a plurality of fingers (tulip shape), and of a main contact 41;
and a second contact 2 that is stationary in this example (but alternatively it can be a movable contact as illustrated on FIGS. 5A and 5B), comprising an arcing contact 22 (a pin in this example) and a main contact 24.

Reference 50 is a pipe located inside the contact 42 which allows gas blast to circulate through it and which may also operate the movable contact.

The arcing contacts are made of a metallic material, for example of copper or of a tungsten alloy.

These two contacts co-operate between a closed position (shown for example on FIG. 5A) in which the two contacts 2, 4 allow electrical current to pass between them, and an open position in which they are separated from each other (shown for example on FIG. 5B). FIGS. 1A-4 show intermediate positions between a fully open and a fully closed position; FIGS. 5A and 5B show a fully closed position (FIG. 5A) and a fully open position (FIG. 5B).

During the breaking procedure, the two main contacts 41, 24 separate first (they are in contact with each other in a closed position), and then the arcing contacts 42, 22 separate, after a latency period, if any, generated by the length of the mutual engagement, forming an electric arc 19 that is extinguished by a compressed insulating gas blasted in the zone between the arcing contacts 22 and 42 subsequently being moved further away.

An insulating nozzle 30 extends between the two contacts 2, 4; It is fixed with respect to the contact 4.

Said insulating nozzle 30 comprises an internal hole 34 (see FIG. 1B) having a cylindrical wall 33 defining a cylindrical volume 36 and extending from an inlet 302 (which faces or is turned towards the arcing contact 42) to an outlet 304 (which faces or is turned towards an exhaust volume 28). Part of the arcing contact 22 is housed in said volume 36, at a distance from said cylindrical wall 33.

During the breaking procedure the arcing contact 22 slides inside said cylindrical volume 36, from a closed position (shown on FIG. 5A) in which arcing contact 22 is in contact with arcing contact 42 to an intermediate position in which they are separated but still relatively close to each other (FIG. 1A), then to a position in which they are further away from each other (FIG. 1B-4) and to a position in which the high voltage circuit-breaker is completely open (FIG. 5B).

Arcing contact 22 comprises at least one inner channel 220 which extends over a distance X between a front inlet 222 of the contact (said front inlet being turned towards the other arcing contact 42) and an end wall 224. Furthermore a lateral conduit 26 extends from said inner channel 220 to the outside surface of the arcing contact, a lateral or radial outlet 27 of said conduit 26 thereby opening in the cylindrical volume 36. Said inner channel 220 has for example a diameter comprised between 1 mm and 8 mm.

Inner channel 220 can be cylindrical: it can have a cross-section (in a plane perpendicular to axis AA′) which is preferably circular but which alternatively can be oval, or rectangular. In another particular embodiment, inner channel 220 can have another shape, for example helicoidal.

When the circuit breaker opens the arcing contacts, an arc 19 is established and between the arcing contacts and hot gas is generated.

This hot gas flows either in the inner channel 220 and/or through the other arcing contact 42, and/or in the small cylindrical volume 36 section between the arcing contact pin 22 and the wall 33 of the central cylindrical hole 34 of the insulating nozzle 30 and/or towards the arcing volume 45 (see FIG. 1B) between tulip 42 and nozzle 30. The inner channel 220 thus allows an additional cross-section to evacuate hot gases.

When the radial outlet 27 of the pin hole is closed by the insulating nozzle 30 (as shown on FIG. 1A), the gas flow is limited.

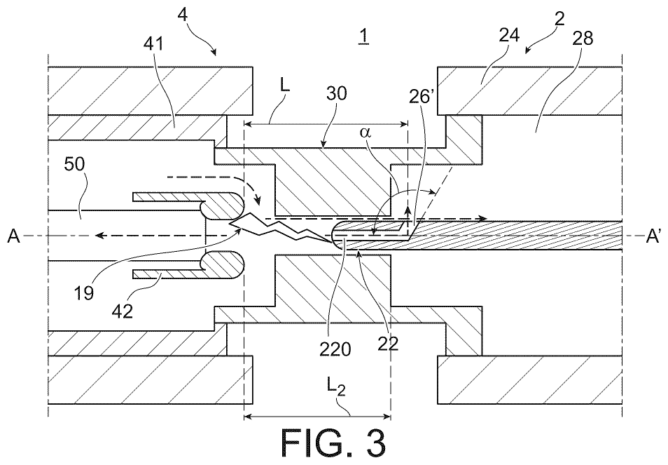

Gas is released through or along inner channel 220 and then through or along the lateral conduct 26 and to an exhaust volume 28 when the radial or lateral outlet 27 is released or no longer in front of the internal wall 33 of the hole 34 (as shown on FIG. 1B). Two gas flows are shown on FIG. 1B and on FIG. 3: one (40) between the arcing contact and the wall 33 of hole 34 and one (43) along the inner channel 220 and lateral conduit 26.

Thus the inner channel 220 inside the arcing contact 22 allows part of the hot gas generated by the arc 19 to flow into the pin arcing contact, then along the lateral conduct 26 and then into the exhaust volume 28.

The arcing contact 22 can comprise a plurality of inner channels 220₁, 220₂, 220₃, as shown on FIG. 1C; they can be parallel to each other. As shown on this figure they can open into a common larger channel 221 from which one or more lateral conduit(s) 26 extend as explained above and below.

As shown on FIGS. 1B and 3, L₂ is the distance between the free end of the arcing contact 42 and the outlet 304.

L is the distance between the free end of the arcing contact 42 and the lateral hole 27; it varies when the device opens or closes: L<L₂ on FIGS. 1A and 2, whereas L>L₂ on FIGS. 1B and 3. When the distance L exceeds the distance L₂, then the lateral outlet 27 of the pin is opened and, starting from this position the interrupter performance is improved. L and L₂ can be selected accordingly; L₂ can for example be comprised between 10 mm and 200 mm.

X (see FIG. 1A) is the fixed length of the channel 220 along the pin 22. L₂>X so that the opening of the outlet 27 is delayed. The larger X, the earlier the outlet 27 opens in the volume 28. For example X is comprised between 10 mm and 150 mm.

Preferably L<L₂ before the arc expected interruption and L>L₂ when the arc is expected to be interrupted.

A variant of the above embodiment is shown on FIG. 2, which comprises at least 2 lateral conduits 261 and 262 extending in 2 different (opposite) direction from the inner channel 220 or 221, thus increasing the gas flow and further improving the performance of the circuit-breaker. More such lateral conduits can be provided, in particular if there is enough material to drill through and for the mechanical function of the pin 22 and also not to overheat when short circuit current will flow through the pin 22.

Another variant is shown on FIG. 3, the lateral conduit(s) 26′ being inclined with respect to axis AA′ so that the gas flowing through the internal channel 220 and the lateral conduit 26′ follows a path having an obtuse angle α; the angle α is strictly higher than 90°. In other words, the lateral conduit 26′ extends along an axis which forms an angle α strictly higher than 90° with the axis (AA′) of the circuit breaker.

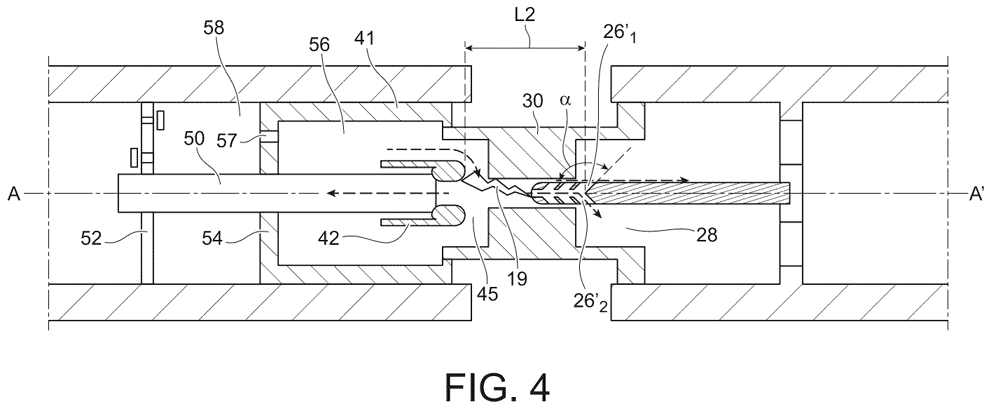

Another variant is shown on FIG. 4, in which 2 lateral conduit 26′₁ and 26′₂ extend from the inner channel 220 and are both inclined with respect to axis AA′ so that the gas flowing through the inner channel 220 and any of these lateral conduits 26′₁ and 26′₂ follows a path having an obtuse angle (with a component oriented opposite to the tip of the pin 22); the complementary angle α is strictly higher than 90°.

According to a further variant (not illustrated) one or more lateral conduit(s) 26, 26′₁, 26′₂ is/are inclined with respect to axis AA′ so that the gas flowing through the inner channel 220 and any of these lateral conduits 26, 26′₁ and 26′₂ follows a path having an acute angle (with a component oriented towards the tip of the pin 22); the angle α is strictly less than 90°, for example comprised between 1° and 90°. In other words, the lateral conduit 26′ extends along an axis which forms an angle α strictly less than 90° with the axis (AA′) of the circuit breaker.

On both FIGS. 3 and 4, and in any embodiment where at least one lateral conduit has an angle with respect to axis AA′, the value of said angle depends on the application and can be estimated through computational fluid dynamic numerical simulations.

More generally, it is possible to have several lateral conduits extending along an axis which forms an angle equal to 90° or higher than 90° or lower than 90° with the axis (AA′) of the circuit breaker.

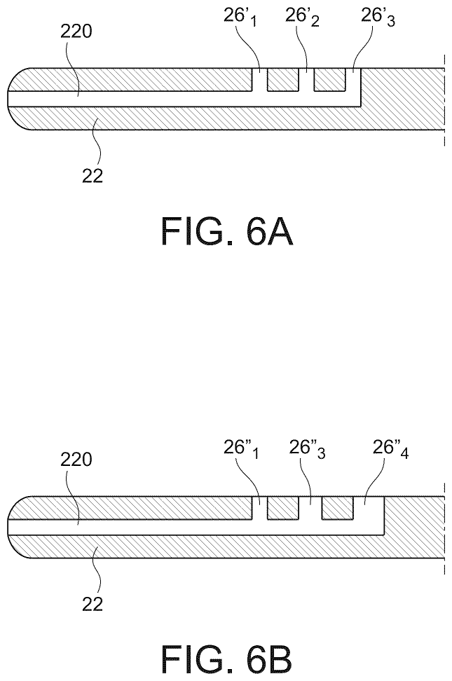

FIGS. 6A and 6B show different embodiments within the scope of the present invention:

FIG. 6A: several lateral conduits 26′₁, 26′₃, 26′₄ aligned along the axis of the pin 22;

FIG. 6B: several lateral conduits 26″₁, 26″₃, 26″₄ aligned along the axis of the pin 22 and having variable or increasing cross sections (measured parallel to axis AA′).

These embodiments and their variants here below provide a gradual cross section opening.

In further embodiments of the invention (not illustrated):
the lateral conduits of FIG. 6A or 6B are inclined with respect to axis AA′ as explained above in connection with FIGS. 3 and 4;
and/or the pin 22 comprises lateral conduits symmetrical to those of FIG. 6A or 6B with respect to axis AA′.

As can be seen on FIG. 4 (but this applies as well to the other figures), the movable contact 42 is housed in a thermal volume 56, located between the arcing volume 45 and a compression volume 58. A wall 54 moves together with the movable contact 42 to reduce the volume of a compression chamber or volume 58, thereby exhausting a gas into the thermal volume 56 (though one or more valve 57 in said wall 54) which contributes to extinguish the arc 19.

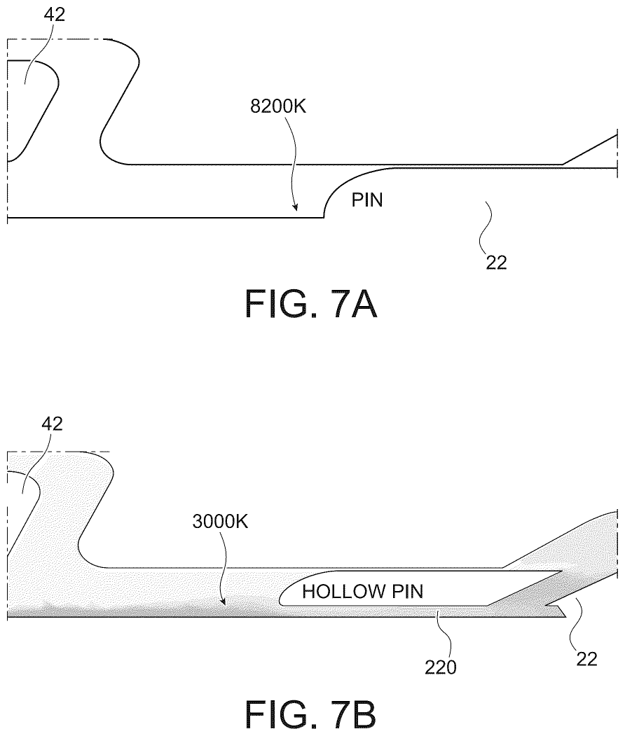

FIGS. 7A and 7B show results of multi-physic arc calculations; they show a comparative example of a nozzle 30 and:
FIG. 7A: a pin 22 without a central channel according to the invention; the temperature of the gas at the end of the pin is higher than 8000 K;
FIG. 7B: a pin according 22 to the invention comprising an inner channel 220 and a lateral inclined conduit 26 as shown on FIG. 3; the temperature of the gas at the tip of the pin 22 (for the same distance as on FIG. 7A between the 2 arcing contacts) is about 3000 K, which is drastically below the temperature of the gas in the example of FIG. 7A.

On both figure reference 42 represents the arcing contact which cooperates with the pin 22.

The invention finds application in high voltage circuit breaker which operate for example under rated voltage above 52 kV and hundreds to thousands of Amps of interrupting currents).

A circuit breaker according to the invention can comprise and operate in a gas, for example SF₆; alternatively, in order to reduce the greenhouse effects resulting from the use of SF₆, the following gas may be used:
a gas comprising heptafluoroisobutyronitrile (CAS No. 42532-60-5) and/or heptafluoroisopropyl trifluoromethyl ketone (also named 2-butanone, 1,1,1,3,4,4,4-heptafluoro-3-(trifluoromethyl)-(CAS No 756-12-7)), possibly mixed with a gas or a dilution gas comprising at least CO₂ and/O₂ and/or N₂ and/or an oxygenated compound;
or in a gas comprising at least CO₂ and/O₂ and/or N₂ and/or an oxygenated compound;
or a gas comprising a mixture of CO₂, O₂ and fluoronitrile, or a mixture of CO₂ and Fluoronitrile, or a mixture of CO₂ and O₂, or a mixture of CO₂, O₂ and Fluoroketone, or a mixture of CO₂ and Fluoroketone, or a mixture of N₂ and fluoronitrile.

The improved performance of a circuit-breaker according to the invention reduces the decomposition of a gas like one of the above mentioned alternative gas.

We claim:

1. A circuit breaker, comprising:
a pair of permanent contacts, at least one of them being movable along an axis, called the axis of the circuit-breaker;
an insulating nozzle comprising a central cylindrical wall defining a longitudinal cylindrical hole, along the axis;
a pair of arcing contacts, at least one of them being movable along the axis, a lateral wall of one of the arcing contacts being at a distance from the central cylindrical wall thereby defining a cylindrical volume between the arcing contact and the central cylindrical wall, the arcing contact further comprising at least one inner channel extending along the axis and along part of the arcing contact, and at least one lateral conduit between the at least one inner channel and at least one lateral hole whereby the at least one inner channel communicates with the cylindrical volume.

2. The circuit breaker according to claim 1, wherein at least one lateral conduit extends along an axis perpendicular to the axis of the circuit breaker.

3. The circuit breaker according to claim 1, wherein at least one lateral conduit extends along an axis which forms an angle equal to 90° or strictly higher than 90° or strictly lower than 90° with the axis of the circuit breaker.

4. The circuit breaker according to claim 1, comprising a plurality of lateral conduits:
located at different positions along the axis;
or located at a same position along the axis.

5. The circuit breaker according to claim 4, comprising a plurality of lateral conduits located at different positions along the axis and having variable or increasing cross sections measured parallel to the axis.

6. The circuit breaker according to claim 1, wherein the at least one inner channel extends along the axis over a distance between 10 mm and 150 mm.

7. The circuit breaker according to claim 1, wherein the at least one inner channel comprises a diameter between 1 mm and 8 mm.

8. The circuit breaker according to claim 1, wherein the at least one inner channel extends along part of the arcing contact from a front end of the arcing contact to a wall in the arcing contact.

9. The circuit breaker according to claim 1, wherein the at least one inner channel is cylindrical, having a circular or oval or rectangular cross section, or is helicoidal.

10. The circuit breaker according to claim 1, comprising a plurality of inner channels.

11. The circuit breaker according to claim 10, wherein the plurality of inner channels open in a common channel.

12. The circuit breaker according to claim 1, wherein the insulating nozzle extends between an inlet turned towards one of the arcing contacts and an outlet turned towards an exhaust chamber.

13. The circuit breaker according to claim 1, further comprising an enclosure filled with a gas.

14. The circuit breaker according to claim 13, wherein the gas comprises SF₆, or heptafluoroisobutyronitrile (CAS No. 42532-60-5) and/or heptafluoroisopropyl trifluoromethyl ketone (also named 2-butanone, 1,1,1,3,4,4,4-heptafluoro-3-(trifluoromethyl)-(CAS No 756-12-7)) and/or CO₂ and/or O₂ and/or N₂ and/or an oxygenated compounds, comprising both CO₂ and a fluorinated compound, comprising heptafluoroisobutyronitrile and/or heptafluoroisopropyl trifluoromethyl ketone;
or a gas comprising a mixture of CO₂, O₂ and fluoronitrile, or a mixture of CO₂ and Fluoronitrile, or a mixture of CO₂ and O₂, or a mixture of CO₂, O₂ and Fluoroketone, or a mixture of CO₂ and Fluoroketone, or a mixture of N₂ and fluoronitrile.

15. A method for opening a circuit-breaker according to claim 1, comprising:
opening the main contacts;
then separating the pair of arcing contacts from each other, thereby triggering an arc between them, a gas flowing along the at least one inner channel, and then along the at least one lateral conduit thereby escaping to the cylindrical volume and then to an exhaust volume.
